(19) United States
(12) Patent Application Publication
(10) Pub. No.: US 2025/0034808 A1
(43) Pub. Date: Jan. 30, 2025

(54) A GASKET ARRANGEMENT FOR A PROTRUDING BAR OF A BOILER AND A METHOD OF OPERATING THE GASKET ARRANGEMENT

(71) Applicant: ANDRITZ OY, Helsinki (FI)

(72) Inventors: Jarkko BRUNOU, Varkaus (FI); Jani RÄSÄNEN, Mikkeli (FI)

(21) Appl. No.: 18/715,592

(22) PCT Filed: Nov. 30, 2022
(86) PCT No.: PCT/FI2022/050800

§ 371 Date: May 31, 2024

(30) Foreign Application Priority Data
Dec. 1, 2021 (FI) 20216229

(51) Int. Cl. D21C 11/12; F16J 15/56; F23G 5/46; F23M 11/02

(52) U.S. Cl. CPC D21C 11/12; F16J 15/56; F23M 11/02; F23G 5/46; F23G 2209/101

(57) ABSTRACT

A sealing arrangement of a protruding bar (1) arranged to enter into a combustion chamber (3) of the boiler through an opening (5) of a wall (4) of the combustion chamber (3). The protruding bar (1) is attached to a handling device (10). The sealing arrangement has a gasket (2) for sealing the opening (5). The gasket (2) is slidably arranged around the protruding bar (1) for sealing a gap between the protruding bar (1) and the wall (4) of the combustion chamber so that sealing arrangement is configured to keep the gasket (2) attached to the wall (4) of the combustion chamber (3) while the protruding bar (1) is fully inserted into the combustion chamber (3) and at least a part of time when the protruding bar (1) enters into the combustion chamber (3) and at least a part of time when the protruding bar (1) retracts from the combustion chamber (3).

### FIELD OF THE INVENTION

The invention relates to a gasket for a protruding bar of a boiler. Preferably the protruding bar has a probe for automatic measurements of a recovery boiler.

### BACKGROUND OF THE INVENTION

A recovery boiler burns dried black liquor as a fuel. The liquor comprises chemicals that are recovered after the burning and other reactions within the boiler. Operating conditions inside liquor burner are hot and corrosive and flue gases are highly contaminant and contain harmful substances. Any openings should be shielded from leaks of gases from inside of a boiler chamber to outside.

Some probes no not resist the conditions long time or are not intended to be within a boiler chamber for a long time. They are often arranged to be occasionally inserted into the boiler chamber with a protruding bar. An example of such a protruding measuring bar is described in publication WO2020260762. Alike protruding bars are for example soot blowing bars of any types of boilers.

### SUMMARY OF THE INVENTION

Automated operation of protruding measurement bars which are temporarily inserted within a combustion chamber should be sealed from leaks of gases and particles from inside of the combustion chamber to outside spaces. Especially flue gases of recovery boilers are thick fumes which contains harmful and sticky substances. Thermal expansions of combustion chamber walls makes difficult to use tight tolerances for the positions and sizes for the openings of the walls. In practice, it is not possible to arrange narrow enough gap between the protruding bar and an opening of a wall of a boiler chamber. A gasket for sealing the gaps should be able to seal the gap also when the protruding bar is entering into the combustion chamber, not just when it is fully inserted into the combustion chamber. That minimizes time for leaking through the gap.

The object of the invention is to achieve a reliable sealing arrangement for a protruding bar of a combustion chamber boiler and a method for operating it. These and other objects that will be apparent from the following summary and description are achieved by the arrangement and the method defined in the appended claims.

The sealing arrangement for a protruding bar of a boiler has a gasket which is slidably arranged around the protruding bar for sealing the gap between the protruding bar and the wall of the combustion chamber. The sealing arrangement comprises also means for attaching the gasket to the wall of the combustion chamber while the protruding bar is inserted into the combustion chamber. The gasket detaches from the wall when the protruding bar retracts from the combustion chamber. So, most of the time during the in and out strokes, the gap around the protruding bar is sealed.

The gasket is preferably attached to the wall of the combustion chamber by at least one magnet attached to the gasket. The gasket may also be attached to the wall of the combustion chamber by at least one fastening element which is operated by an actuator or a spring. The fastening element may have a hook form or it may frictionally attach to the gasket. The protruding bar preferably has a protrusion which connects to the gasket and detaches it from the wall of the combustion chamber while the protruding bar retracts from the combustion chamber. The gasket may also be attached to the wall of the combustion chamber by a spring pushing it against the wall. The other end of the spring is fixed to or at least against a form of the protruding bar or the handling device. The other end of the spring may be fixed to the gasket, so it will automatically detach without having the protrusion of the protruding bar. The method should also work with manual operations without a handling device moving the protruding bar.

The opening of the combustion chamber is covered by a hatch which is opened by an opening actuator just before the protruding bar enters into the combustion chamber. The hatch is closed just after the protruding bar is retracted from the combustion chamber for minimizing unsealed times.

### BRIEF DESCRIPTION OF THE DRAWINGS

The invention will now be described in more detail with reference to the appended drawings in which:

FIG. 1 illustrates a preferred embodiment of the invention wherein a gasket is attached to a wall of a combustion chamber by a magnet,

FIG. 2 illustrates an embodiment of the invention wherein a gasket is attached to a wall of a combustion chamber by a fastening element and

FIG. 3 illustrates an embodiment of the invention wherein a gasket is attached to a wall of a combustion chamber by a spring on a protruding bar.

### DETAILED DESCRIPTION OF THE INVENTION

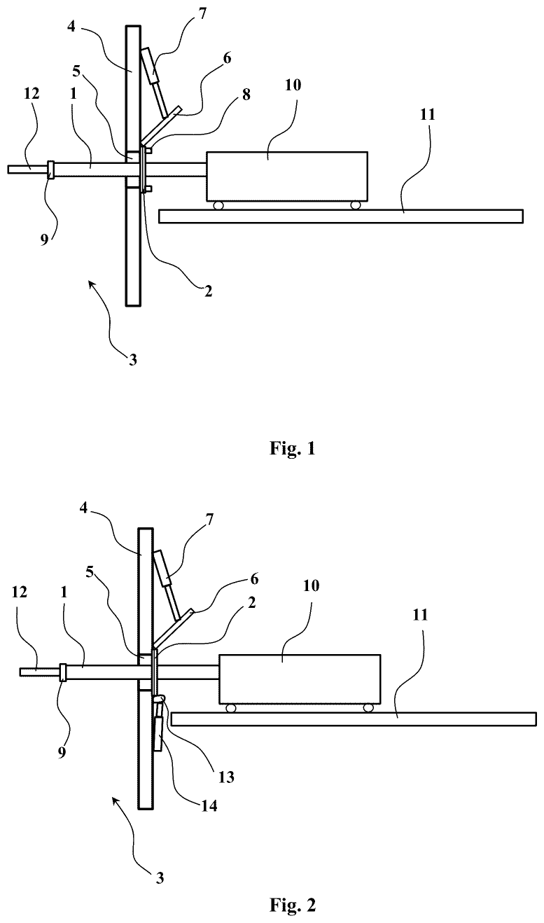

FIG. 1 illustrates a preferred embodiment of a sealing arrangement comprising a gasket 2 which is arranged around a protrusion bar 1 and attached to a wall 4 of a combustion chamber 3 of a boiler by a magnet 8 attached to the gasket 2. The protrusion bar 1 is in this case for measuring carryover particles from flue gases of a recovery boiler. The protrusion bar 1 is inserted into the combustion chamber 3 through an opening 5 of the wall 4. The in and out strokes are made by a handling device 10. The handling device 10 operates on a platform 11. The handling device 10 may be a programmable manipulator like a robot or it may be operated by a pressurized cylinder or electromechanically. It may perform also other handling actions than the in and out strokes. Just before the insertion, an opening actuator 7 opens a hatch 6 which covers the opening 5. The operations needed to perform the programmed tasks are controlled for example by a controller of the handling device 10 or a controller of the boiler.

The gasket 2 may comprise a metal plate and a refractory covering on the combustion chamber side of the plate. The gasket 2 should fit to the form of the protruding bar with suitable gap between them, so that it still can slide freely on the protrusion bar 1. Before the protrusion bar 1 enters into the combustion chamber 3, the gasket 2 is first loosely stationed on the protrusion bar 1. When the protrusion bar 1 is entering inside the combustion chamber 3 and the gasket touches the wall 4, the magnet 8 attaches the gasket 2 to the wall 4. When the measurement cycle is over, the protrusion bar 1 retracts. Then a protrusion 9 of the protrusion bar 1 detaches the gasket 2 from the wall 4. The protrusion 9 may also be a shoulder of the protrusion bar 1. After the retraction, the opening actuator 7 closes the hatch 6. In this case, the thinner end of the protrusion bar 1, which enters into the combustion chamber 3 is for collecting measured carryover particles. Thus, the gasket 2 nor the wall 4 should not contact carryover collecting area 12. So, the area between the outer end of the protrusion 9, the protrusion bar 1 is momentarily not sealed by the gasket 2 during the in and out strokes.

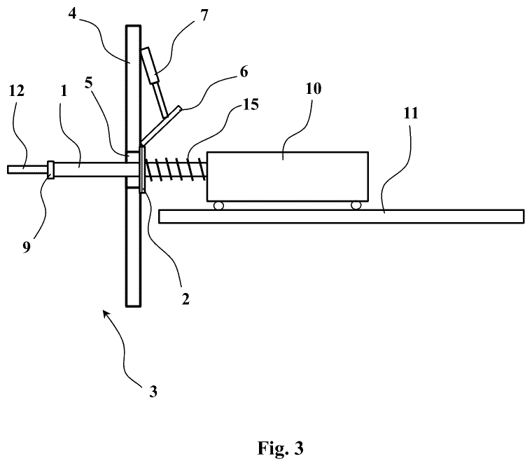

FIG. 2 illustrates an embodiment of the sealing arrangement wherein the gasket 2 is attached to the wall 4 of the combustion chamber 3 by at least one but preferably at least two fastening elements 13. The fastening element 13 may hold the gasket 2 attached against the wall 4 frictionally or it may have hooked form for the attachment. Especially with the hooked form, a holding actuator 14 should be used for opening and closing the fastening element 13. A spring may be used instead the actuator 14 for pushing the fastening element 13 against the gasket 2 for creating frictional holding force. Another protrusion 9 on the protrusion bar 1 on the other side of the gasket 2 could push the gasket 2 between the spring actuated frictional fastening elements 13, especially with the type of attachment which is illustrated in FIG. 3.

FIG. 3 illustrates an embodiment of the invention wherein the gasket 2 is attached to a wall of a combustion chamber by a spring 15. The gasket 2 is pushed against the wall 4 of the combustion chamber 3 by a spring 15. The inner end of the spring 15 is connected to the protruding bar 1 or to the handling device 10. Preferably the spring is fixed to the gasket. The protrusion 9 at the outer end of the protrusion bar 1 can take the gasket out of contact, when the protrusion bar 1 retracts, if the gasket 2 is not fixed to the spring 15 nor to the protrusion bar 1 or to the handling device 10. The attachment methods presented in connection with FIGS. 1 to 3 may be mixed with each other.

1. A scaling arrangement for a protruding bar of a boiler, wherein the protruding bar is arranged to enter into a combustion chamber of the boiler through an opening of a wall of the combustion chamber and the protruding bar is attached to a handling device, wherein the scaling arrangement includes:
a gasket around the protruding bar configured to seal a gap in the opening between the protruding bar and the wall of the combustion chamber;
an attachment device configured to attach the gasket to the wall of the combustion chamber while the protruding bar is fully inserted into the combustion chamber, and at least a part of time while the protruding bar enters the combustion chamber and at least a part of time while the protruding bar retracts from the combustion chamber.

2. The sealing arrangement of claim 1, wherein the attachment device includes a magnet on the gasket and attaches the gasket to the wall of the combustion chamber.

3. The sealing arrangement of claim 1, wherein the attachment device includes at least one fastening element which is configured to attached the gasket to the wall of the combustion chamber, wherein the fastening element is operated by a holding actuator or a spring.

4. The sealing arrangement of claim 1, wherein attachment device includes a spring on the protruding bar and biasing the gasket to the wall of the combustion chamber.

5. The sealing arrangement of claim 2, wherein the protruding bar has a protrusion or an elbow which connects to the gasket and detaches the gasket from the wall of the combustion chamber while the protruding bar retracts from the combustion chamber.

6. The sealing arrangement of claim 1, wherein the gasket comprises a metal plate and a refractory covering on a combustion chamber side of the metal plate.

7. The sealing arrangement of claim 1, wherein the boiler is a recovery boiler of a pulp mill.

8. A method comprising:
inserting a distal portion of a protruding bar through an opening in a wall of a combustion chamber in a boiler and advancing the distal portion into the combustion chamber;
positioning a gasket around and on the protruding bar and advancing the gasket to an exterior surface of the wall as the distal portion of the protruding bar is inserted into the opening;
sealing a gap in the opening between the protruding bar and the wall of the combustion chamber by attaching the gasket to the wall such that the gasket covers the opening; and
detaching the gasket from the wall of the combustion chamber as the protruding bar retracts from the combustion chamber.

9. The method of claim 8, further comprising attaching the gasket to the to the wall of the combustion chamber using at least one magnet.

10. The method of claim 8, further comprising attaching the gasket to the wall of the combustion chamber by at least one fastening element, and
operating the at least one fastening element using a holding actuator or a spring to attach the gasket to the wall.

11. The method of claim 8, wherein the gasket attaches to the wall of the combustion chamber by a biasing force applied by a spring on the protruding bar connected to the protruding bar or to the handling device.

12. The method of claim 8, further comprising opening a hatch covering the opening in the wall before the insertion of the protruding bar into the combustion chamber, and
closing the hatch to cover the opening in the wall after the protruding bar is retracted from the combustion chamber.

13. The method of claim 8, wherein, the boiler is a recovery boiler of a pulp mill.

14. A method comprising:
advancing a distal portion of a protruding bar through an opening in a wall of a combustion chamber of a recovery boiler and into the combustion chamber using a handling device attached to a proximal portion of the protruding bar;
advancing a gasket towards an exterior surface of the wall of the combustion chamber, wherein the protruding bar extends through an aperture in the gasket and the gasket advances with the protruding bar until the gasket abuts the exterior surface which stops further advancement of the gasket;
attaching the gasket to the exterior surface such that the gasket substantially covers the opening to form a seal between the protruding bar and the wall;
continuing the advancement of the distal portion of the protruding bar into the combustion chamber while the gasket abuts the exterior surface of the wall and as the gasket slides relative to the protruding bar;
retracting, with the handling device, the distal portion of the protruding bar from the combustion chamber, wherein during an initial portion of the traction the gasket remains attached to the exterior surface of the wall and while attached the gasket slides along the retracting protruding bar, and
detaching the gasket from the exterior surface of the wall by a force applied to the gasket by a protrusion or elbow engaging the gasket, wherein the protrusion or elbow is on the distal portion of the protruding bar and engages the gasket during a subsequent period of the retraction.

15. The method of claim 14, wherein the attaching of the gasket to the exterior surface includes using a magnet on the gasket to attach the gasket to the exterior surface.

16. The method of claim 14, wherein the attaching the gasket to the exterior surface includes applying a bias force to the gasket, wherein the bias force applied by a spring around the protruding bar and between the gasket and the handling device.

17. The method of claim 14, wherein the gasket includes a metal plate with a refractory covering on a side of the metal plate facing the wall of the combustion chamber.

18. The method of claim 14, wherein the handling device includes wheels which roll over a platform adjacent to the recovery boiler to move the handling device towards the combustion chamber during the advancement of the distal portion of the protruding bar, and to move the handling device away from the recovery boiler during the retraction of the distal portion of the protruding bar.
